(19) United States
(12) Patent Application Publication
(10) Pub. No.: US 2023/0045538 A1
(43) Pub. Date: Feb. 9, 2023

(54) CONTROL DEVICE, CONTROL METHOD, AND STORAGE MEDIUM

(71) Applicant: KABUSHIKI KAISHA TOKAI RIKA DENKI SEISAKUSHO, Aichi (JP)

(72) Inventors: Shingo MOCHIZUKI, Aichi (JP); Toshihiro TSUTSUI, Aichi (JP)

(73) Assignee: KABUSHIKI KAISHA TOKAI RIKA DENKI SEISAKUSHO, Aichi (JP)

(21) Appl. No.: 17/852,801

(22) Filed: Jun. 29, 2022

(30) Foreign Application Priority Data
Aug. 6, 2021 (JP) 2021-129855

(51) Int. Cl. E05F 15/43

(52) U.S. Cl. CPC E05F 15/43; E05F 2015/433; E05Y 2201/41; E05Y 2201/422; E05Y 2400/54; E05Y 2900/531

(57) ABSTRACT

To provide a new and improved control device, control method, and storage medium capable of detecting with higher accuracy whether an object exists in an opening/closing range of a door.

A control device includes a control unit configured to perform a control of calculating position information of an object, on the basis of distances between a distance measurement sensor provided on a hinge-type door and the object, the distances being obtained by the distance measurement sensor at two or more positions in an opening/closing range of the door.

### CROSS REFERENCE TO RELATED APPLICATION(S)

This application is based upon and claims benefit of priority from Japanese Patent Application No. 2021-129855, filed on Aug. 6, 2021, the entire contents of which are incorporated herein by reference.

### BACKGROUND

The present invention relates to a control device, a control method, and a storage medium.

Recently, there has been developed a technology of controlling opening and closing of a structure such as a door. For example, Japanese Patent Application Laid-open No. 2014-194151 discloses the technology of performing a control, when a stop signal is input during opening and closing of a sliding door, so that a brake force is generated at an electric motor to stop opening and closing of the sliding door.

### SUMMARY

However, the technology described in Japanese Patent Application Laid-open No. 2014-194151 does not detect whether a person, an object, or the like exists in an opening/closing range of a door when the door is opened or closed. Therefore, if a person or an object exists in an opening/closing range of a door, for example, the door may come into contact with the person or the object.

Then, in view of the above-described problem, the present invention aims at providing a new and improved control device, control method, and storage medium capable of detecting with higher accuracy whether an object exists in an opening/closing range of a door.

To solve the foregoing problem, according to an aspect of the present invention, there is provided a control device, comprising: a control unit configured to perform a control of calculating position information of an object, on the basis of distances between a distance measurement sensor provided on a hinge-type door and the object, the distances being obtained by the distance measurement sensor at two or more positions in an opening/closing range of the door.

To solve the foregoing problem, according to another aspect of the present invention, there is provided a control method performed by a computer, the control method comprising: performing a control of calculating position information of an object, on the basis of distances between a distance measurement sensor provided on a hinge-type door and the object, the distances being obtained by the distance measurement sensor at two or more positions in an opening/closing range of the door.

To solve the foregoing problem, according to another aspect of the present invention, there is provided a non-transitory computer readable storage medium storing a program, the program controlling a computer to achieve: a control function for performing a control of calculating position information of an object, on the basis of distances between a distance measurement sensor provided on a hinge-type door and the object, the distances being obtained by the distance measurement sensor at two or more positions in an opening/closing range of the door.

As described above, in the present invention, it is possible to detect with higher accuracy whether an object exists in an opening/closing range of a door.

### BRIEF DESCRIPTION OF THE DRAWINGS

FIG. 1 is a block diagram illustrating a configuration example of a vehicle according to an embodiment;

FIG. 2 is a bird's-eye view of the vehicle according to the embodiment;

FIG. 3 is an explanatory diagram for explaining an example of one-time distance measurement processing according to the embodiment;

FIG. 4 is an explanatory diagram for explaining an example related to calculation of position information in two-time distance measurement processing according to the embodiment;

FIG. 5 is an explanatory diagram for explaining an example related to calculation of position information in three-time distance measurement processing according to the embodiment; and

FIG. 6 is a flowchart diagram for explaining an example of operation processing of a control device according to the embodiment.

### DETAILED DESCRIPTION OF THE EMBODIMENT(S)

Hereinafter, referring to the appended drawings, preferred embodiments of the present invention will be described in detail. Note that, in this specification and the appended drawings, structural elements that have substantially the same function and structure are denoted with the same reference numerals, and repeated explanation of these structural elements is omitted.

### 1. Configuration Example of Vehicle

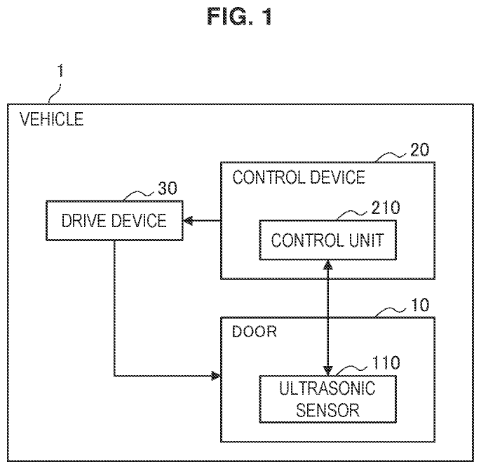

First, a schematic configuration of a vehicle according to the embodiment will be described with reference to FIG. 1. FIG. 1 is a block diagram illustrating a configuration example of a vehicle according to the embodiment. As illustrated in FIG. 1, a vehicle 1 of the embodiment includes a door 10, a control device 20, and a drive device 30.

### Vehicle 1

The vehicle 1 is an example of the mobile body. The vehicle 1 is a vehicle used by a user, for example. The vehicle 1 is a vehicle owned by a user or a vehicle temporarily rented to a user, for example. Note that the examples of the mobile body of the embodiment include not only the vehicle 1 but also an airplane, a ship, and the like.

### Door 10

The door 10 is a hinge-type door provided in the vehicle 1. For example, a user is able to get on the vehicle 1 or get off the vehicle 1 by opening and closing the door 10. Note that the door 10 of the embodiment may be a front door or a rear door of the vehicle 1. Moreover, the door 10 may be a back door or a falcon wing door.

Moreover, the door 10 of the embodiment is opened and closed through the drive device 30, in accordance with the control by the control device 20 described later.

As illustrated in FIG. 1, the door 10 of the embodiment includes an ultrasonic sensor 110. For example, the door 10 of the embodiment includes one ultrasonic sensor 110. Moreover, the door 10 of the embodiment may include a plurality of ultrasonic sensors 110.

The ultrasonic sensor 110 is an example of the distance measurement sensor. The ultrasonic sensor 110 transmits an ultrasonic wave as a transmission wave, in accordance with the control by the control unit 210, for example. Next, the ultrasonic sensor 110 receives a reflected wave occurred by reflection of the transmission wave by an object. Then, the ultrasonic sensor 110 detects a distance between the ultrasonic sensor 110 and the object having reflected the transmission wave, on the basis of time from the transmission of the ultrasonic wave to the reception of the reflected wave. Such a sequence of processing related to the detection of a distance between the ultrasonic sensor 110 and an object is referred to as distance measurement processing. Note that the distance measurement sensor according to the embodiment may be an optical distance measurement sensor or a radio distance measurement sensor using millimeter waves.

### Control Device 20

The control device 20 controls the entire operation of the vehicle 1. As illustrated in FIG. 1, the control device 20 includes a control unit 210.

The control unit 210 controls the entire operation of the control device 20. For example, the control unit 210 performs a control of calculating position information of an object, on the basis of distances between the ultrasonic sensor 110 and the object. The distances are obtained by the ultrasonic sensor 110 at two or more positions in the opening/closing range of the door 10.

Moreover, the control device 210 may perform a control of opening and closing the door 10 in accordance with the calculated position information of the object. For example, the control unit 210 controls the drive device 30 described later to open and close the door, in accordance with the calculated position information of the object. Note that the function of the control unit 210 for controlling the opening and closing the door 10 may be achieved by a device different from the control device 20.

Moreover, the ultrasonic sensor 110 of the embodiment performs distance measurement processing at two or more positions in the opening range of the door 10, and obtains information related to two or more distances between the ultrasonic sensor 110 and the object. Then, when the position information of the object based on two or more distances obtained by the ultrasonic sensor 110 is included in the opening/closing range of the door, the control unit 210 may stop an opening action of the door.

The control unit 210 functions as an arithmetic processing device or a control device, and controls the operation of each structural element of the control device 20 entirely or partially, on the basis of various programs recorded on a read only memory (ROM), a random access memory (RAM), a removable recording medium, or the like.

The control unit 210 may be achieved by a processor such as a central processing unit (CPU) or a micro controller unit (MCU). Moreover, the control unit 210 may be also achieved by an electronic control unit (ECU) provided in the vehicle 1, a microcomputer provided in the ECU, or the like.

### Drive Device 30

The drive device 30 operates the door 10 in accordance with the control by the control unit 210. For example, the drive device 30 moves the door 10 in the opening direction, in accordance with the control related to an opening action by the control unit 210. Moreover, the drive device 30 moves the door 10 in the closing direction, in accordance with the control related to a closing action by the control unit 210. The drive device 30 may be an arbitrary actuator capable of moving the door 10.

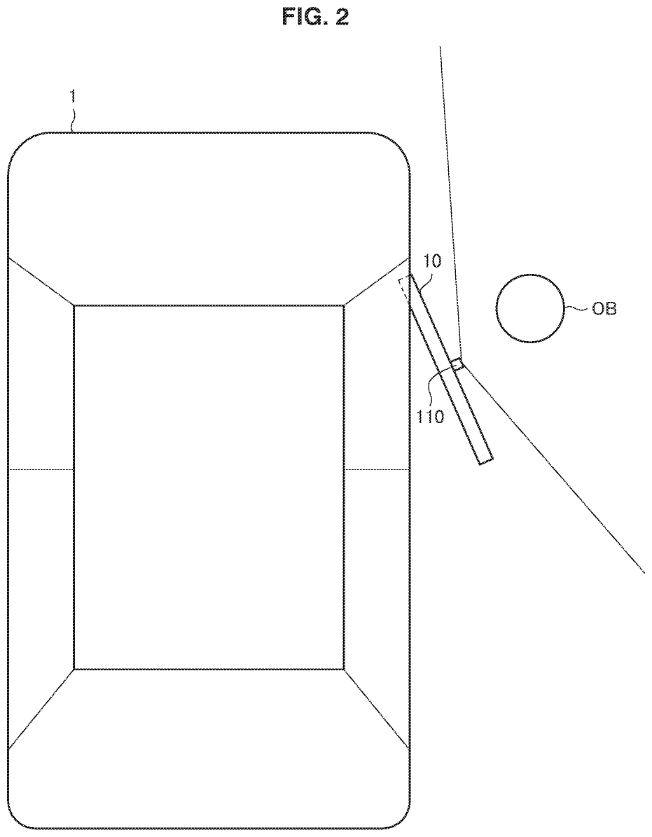

The above has described the configuration example of the vehicle 1 according to the embodiment. The following will describe the embodiment in detail with reference to FIG. 2.

### 2. Details

### 2.1. Arrangement Example of Ultrasonic Sensor 110

FIG. 2 is a bird's-eye view of the vehicle 1 according to the embodiment. The following description exemplifies a case where a user moves the door 10 in an opening direction of the door 10. However, the control unit 210 of the embodiment is also applicable to a case where a user moves the door 10 in a closing direction of the door 10. Note that in the following description, the direction for opening the door 10 may be referred to as an opening direction and the direction for closing the door 10 may be referred to as a closing direction.

The ultrasonic sensor 110 is provided on at least one of a surface on the closing direction side of the door 10 and a surface on the opening direction side thereof, depending on a detecting direction of position information of an object OB. For example, in the case of detecting the position information of the object OB existing in the opening direction of the door 10, the ultrasonic sensor 110 is provided on the surface on the opening direction side of the door 10, as illustrated in FIG. 2. Moreover, in the case of detecting the position information of the object OB existing in the closing direction of the door 10, the ultrasonic sensor 110 is provided on the surface on the closing direction side of the door 10.

The present specification mainly describes an example where the ultrasonic sensor 110 is provided on the center position of the door 10, as illustrated in FIG. 2. However, the ultrasonic sensor 110 may be provided at an arbitrary position on the surface of the door 10.

Moreover, the detection range of the ultrasonic sensor 110 may differ depending on the functions of the ultrasonic sensor 110. The detection range of the ultrasonic sensor 110 of the embodiment may be any range. For convenience of explanation, the following will describe an example where the ultrasonic sensor 110 having a detection range of 0° to 18° is provided on the surface on the opening direction side of the door 10.

### 2.2. Details of Calculation of Position Information

### One-Time Distance Measurement Processing

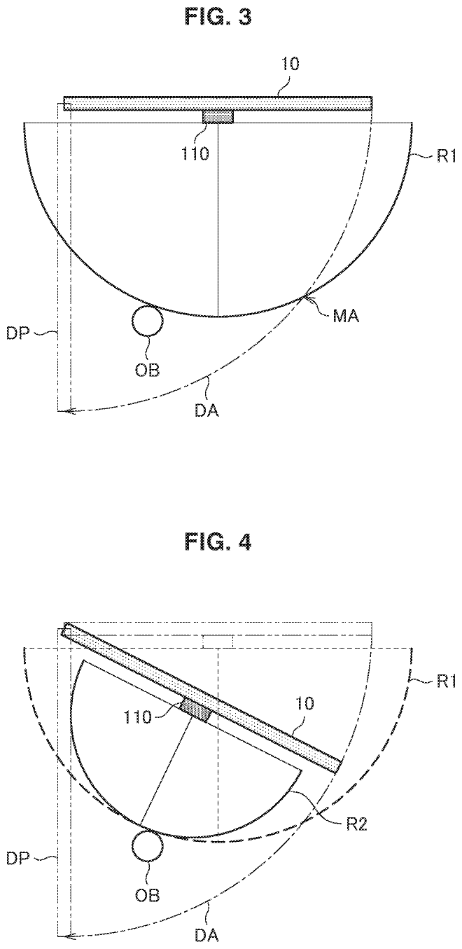

FIG. 3 is an explanatory diagram for explaining an example of one-time distance measurement processing according to the embodiment. The control unit 210 performs a control of opening the door 10 in an opening/closing range DA of the door 10. For example, in the opening/closing range DA of the door 10, the position of the door 10 when opened most is referred to as a fully opening position DP of the door 10. Moreover, the control by the control unit 210 to move the door 10 in the opening direction may be referred to as an opening action, and the control by the control unit 210 to move the door 10 in the closing direction may be referred to as a closing action.

First, the ultrasonic sensor 110 performs the first distance measurement processing at an arbitrary position of the door 10. For example, the ultrasonic sensor 110 performs distance measurement processing in a state where the door 10 is closed completely. The ultrasonic sensor 110 performs distance measurement processing in a state where the door 10 is closed completely, and obtains information of a distance R1 between the ultrasonic sensor 110 and the object OB.

In this manner, in one-time distance measurement processing, it is possible to obtain the information related to the distance R1 between the ultrasonic sensor 110 and the object OB, while it is difficult to obtain the detailed information of the object, such as a direction and a coordinate position thereof. For example, when the ultrasonic sensor 110 obtains only the information of the distance R1 illustrated in FIG. 3, it is difficult to determine whether the object OB is in the opening/closing range DA of the door 10 or it is outside the opening/closing range DA thereof. Therefore, when the control 210 performs a control of opening the door 10 to the fully opening position DP, for example, the door 10 may come into contact with the object OB.

Then, the control unit 210 performs a control of opening the door 10 to an arbitrary position. For example, the control unit 210 opens the door 10 to a position of an intersection MA of an arc separated from the ultrasonic sensor 110 by a distance R1 and the opening/closing range DA at the end position of the door 10, or to an arbitrary position before the intersection MA. Thus, the control unit 210 is able to slightly open the door 10 in a range where the door 10 does not come into contact with the object OB.

### Two-Time Distance Measurement Processing

FIG. 4 is an explanatory diagram for explaining an example related to calculation of position information in two-time distance measurement processing according to the embodiment.

After the first distance measurement processing described with reference to FIG. 3, the control unit 210 opens the door 10 to an arbitrary position, and then the ultrasonic sensor 110 performs the second distance measurement processing. For example, the ultrasonic sensor 110 performs the second distance measurement processing at an arbitrary position to which the door 10 has been opened by the control unit 210, or at a position in the middle of opening of the door 10, and obtains information related to a distance R2 between the ultrasonic sensor 110 and the object OB.

Then, the control unit 210 performs a control of calculating position information of the object OB on the basis of the distance R1 in the first distance measurement processing and the distance R2 in the second distance measurement processing. Thus, the control unit 210 is able to detect with higher accuracy whether the object OB exists in the opening/closing range DA of the door 10.

For example, the control unit 210 calculates two two-dimensional coordinate positions as candidates for the position of the object OB, on the basis of the distance R1 in the first distance measurement processing and the distance R2 in the second distance measurement processing. In this manner, the control unit 210 is able to limit the candidate for the two-dimensional coordinate position of the object OB to two points, and perform a control of opening and closing the door 10 on the basis of the more detailed position information of the object OB.

Then, when the position information of the object OB calculated by the control unit 210 is included in the opening/closing range DA of the door 10, the control unit 210 may perform a control of stopping the opening action of the door 10. For example, the control unit 210 controls the opening action of the door 10 so that the door 10 does not come into contact with the object OB. Thus, it is possible to reduce a possibility that the door 10 comes into contact with the object OB.

Moreover, the control unit 210 may perform a control of stopping the opening action of the door 10 immediately before the door 10 reaches one coordinates having a possibility of coming into contact with the door 10 earlier than the other from the two candidates for the two-dimensional coordinates of the object OB that are obtained by two-time distance measurement processing.

Moreover, when one of the two two-dimensional coordinate positions is outside the opening/closing range DA of the door 10, the control unit 210 may open the door 10 to a position before the other two-dimensional coordinate position.

Moreover, when both of the two two-dimensional coordinate positions are outside the opening/closing range DA of the door 10, the control unit 210 may open the door 10 to an arbitrary position.

Moreover, as described above, in a case where the control unit 210 calculates a plurality of candidates for the position of the object OB, the control unit 210 may stop an opening action of the door 10 when at least one position information of the object OB is included in the opening/closing range of the door 10.

Moreover, when the door 10 has come into contact with the object OB during opening or closing of the door 10, the control unit 210 may stop opening or closing of the door 10. In this manner, when the door 10 has come into contact with the object OB, the control unit 210 is able to control the door 10 not to further move in the opening direction.

As described above, with two-time distance measurement processing, the control unit 210 is able to calculate the candidate for the two-dimensional coordinate position of the object OB, and perform a control of opening and closing the door 10 on the basis of the more detailed position information of the object OB.

### Three-Time Distance Measurement Processing

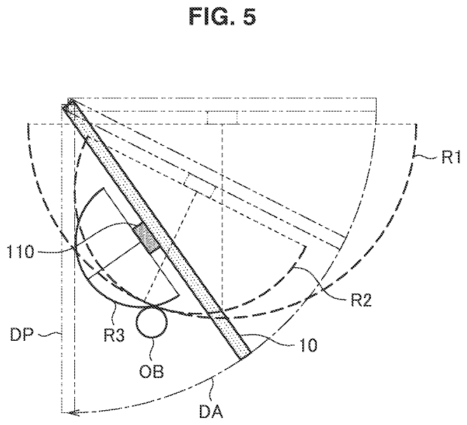

FIG. 5 is an explanatory diagram for explaining an example related to calculation of position information in three-time distance measurement processing according to the embodiment.

For example, the ultrasonic sensor 110 performs the third distance measurement processing at a position after the door 10 is opened further by the control unit 210, or at a position in the middle of further opening of the door 10, and obtains information related to a distance R3 between the ultrasonic sensor 110 and the object OB.

Then, the control unit 210 performs a control of calculating position information of the object OB on the basis of the distance R1 in the first distance measurement processing, the distance R2 in the second distance measurement processing, and the distance R3 in the third distance measurement processing.

For example, the control unit 210 calculates one two-dimensional coordinate position of the object OB on the basis of the distance R1 in the first distance measurement processing, the distance R2 in the second distance measurement processing, and the distance R3 in the third distance measurement processing. Thus, the control unit 210 is able to detect with higher accuracy whether the object OB exists in the opening/closing range DA of the door 10.

Then, the control unit 210 controls the drive device 30 to open the door 10 such that the door 10 does not come into contact with the calculated two-dimensional coordinate position of the object OB. For example, the control unit 210 opens the door 10 to a position immediately before the calculated two-dimensional coordinate position of the object OB.

As described above, with three-time distance measurement processing, the control unit 210 is able to specify the two-dimensional coordinate position of the object OB, and perform a control of opening and closing the door 10 on the basis of the more detailed position information of the object OB.

Moreover, the ultrasonic sensor 110 may constantly perform distance measurement processing. In this case, the control unit 210 may obtain results of distance measurement processing from the ultrasonic sensor 110, regarding each position of the door 10 described above in the first to third distance measurement processing.

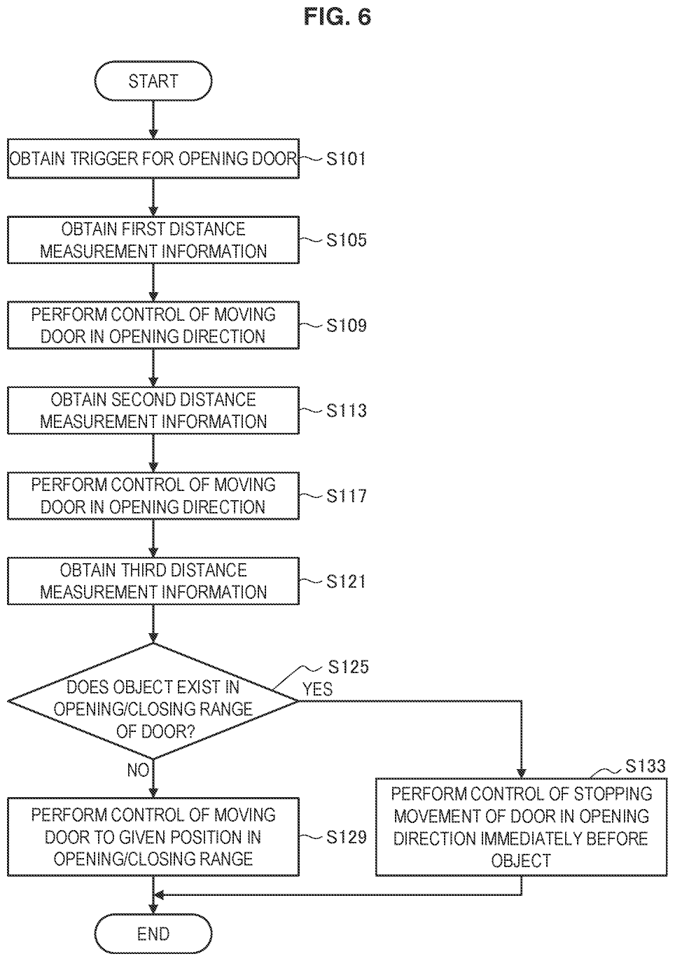

The above has described the details of the embodiment. The following will describe an example of operation processing of the control device 20 according to the embodiment with reference to FIG. 6.

### 3. Example of Operation Processing

FIG. 6 is a flowchart diagram for explaining an example of operation processing of the control device 20 according to the embodiment. In the following description, the information related to a distance between the ultrasonic sensor 110 and an object that is obtained in distance measurement processing may be referred to as distance measurement information. First, the control unit 210 receives a trigger signal for opening the door 10 (S101).

Then, the control unit 210 obtains the first distance measurement information detected by the ultrasonic sensor 110 (S105).

Then, the control unit 210 performs a control of moving the door in the opening direction (S109). For example, the control unit 210 opens the door 10 to an arbitrary position in a range where the door 10 does not come into contact with the object, on the basis of the first distance measurement information detected by the ultrasonic sensor 110.

Then, after opening the door 10 to an arbitrary position in a range where the door 10 does not come into contact with the object, the control unit 210 obtains the second distance measurement information detected by the ultrasonic sensor 110 (S113).

Then, the control unit 210 performs a control of further moving the door in the opening direction (S117). For example, the control unit 210 further opens the door 10 to an arbitrary position in a range where the door 10 does not come into contact with the object, on the basis of distance measurement information of two time detected in two-time distance measurement processing by the ultrasonic sensor.

Then, after further opening the door 10 to an arbitrary position in a range where the door 10 does not come into contact with the object, the control unit 210 obtains the third distance measurement information detected by the ultrasonic sensor 110 (S121).

Then, the control unit 210 determines whether an object exists in the opening/closing range of the door 10 (S125). When it is determined that an object exists (Yes at S125), the control unit 210 shifts the processing to S133. When it is determined that an object does not exist (No at S125), the control unit 210 shifts the processing to S129.

When it is determined that an object exists (Yes at S125), the control unit 210 performs a control of stopping the movement of the door 10 in the opening direction immediately before the object (S133).

When it is determined that an object does not exist (No at S125), the control unit 210 performs a control of moving the door 10 to a given position in the opening/closing range of the door 10 (S129). Note that a given position may be an arbitrary position. For example, a given position may be a fully opening position of the door 10, or a position at which the door 10 is open to a degree allowing a user to pass.

The above has described an example of operation processing of the control device 20 according to the embodiment. In the control device 20 described above, it is possible to detect with higher accuracy whether an object exists in the opening/closing range of the 10 door when the door 10 is opened or closed.

Moreover, in the embodiment, the control unit 210 is able to calculate a target two-dimensional coordinate position with high accuracy even when only one ultrasonic sensor 110 is provided on the door 10. Therefore, it is possible to reduce costs required to calculate a target two-dimensional coordinate position with high accuracy.

Moreover, in the case of using a wide-angle distance measurement sensor, an object outside an opening/closing range of a door may be also detected. This requires the control unit to perform a control of stopping an opening action or a closing action of the door, even when an object does not actually exist in the opening/closing range of the door. Meanwhile, the control unit 210 of the embodiment performs distance measurement processing at least twice in the opening/closing range of the door 10, whereby it is possible to detect with higher accuracy whether an object exists in the opening/closing range of the door 10.

### 4. Supplement

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

For example, a sequence of processing by the devices described in this specification may be achieved using any one of software, hardware, and the combination of software and hardware. Programs forming the software are preliminarily stored in non-transient storage media provided inside or outside the devices, for example. Then, each program is read in a RAM when executed by a computer, and executed by a processor such as a central processing unit (CPU), for example. The above-described recording medium is, for example, a magnetic disk, an optical disk, a magneto-optical disk, a flash memory, or the like. Moreover, the above-described computer program may be distributed through a network, for example, without using any recording medium.

What is claimed is:

1. A control device, comprising:
a control unit configured to perform a control of calculating position information of an object, on the basis of distances between a distance measurement sensor provided on a hinge-type door and the object, the distances being obtained by the distance measurement sensor at two or more positions in an opening/closing range of the door.

2. The control device according to claim 1, wherein the control unit performs a control of opening and closing the door in accordance with the calculated position information of the object.

3. The control device according to claim 2, wherein the control unit stops opening and closing of the door when the calculated position information of the object is included in the opening/closing range of the door.

4. The control device according to claim 3, wherein the control unit stops opening and closing of the door so that the door does not come into contact with the object, when the calculated position information of the object is included in the opening/closing range of the door.

5. The control device according to claim 2, wherein the control unit stops opening and closing of the door when a plurality of candidates for a position of the object are calculated and at least one piece of position information of the object is included in the opening/closing range of the door.

6. The control device according to claim 1, wherein the control unit stops opening and closing of the door when the door has come into contact with the object.

7. The control device according to claim 1, wherein
the two or more positions is three or more positions, and
the control unit performs a control of calculating a two-dimensional coordinate position of the object on the basis of distances between the distance measurement sensor and the object, the distances being obtained at the three or more positions.

8. The control device according to claim 2, wherein
the distance measurement sensor obtains distances between the distance measurement sensor and the object at two or more positions in an opening range of the door, and
the control unit stops an opening action of the door when the position information of the object based on the distances between the distance measurement sensor and the object is included in the opening range of the door, the position information being obtained by the distance measurement sensor.

9. The control device according to claim 1, wherein one distance measurement sensor is provided on the door.

10. The control device according to claim 1, further comprising:
the distance measurement sensor.

11. The control device according to claim 1, wherein the distance measurement sensor includes an ultrasonic sensor.

12. The control device according to claim 1, wherein the door is provided in a mobile body.

13. A control method performed by a computer, the control method comprising:
performing a control of calculating position information of an object, on the basis of distances between a distance measurement sensor provided on a hinge-type door and the object, the distances being obtained by the distance measurement sensor at two or more positions in an opening/closing range of the door.

14. A non-transitory computer readable storage medium storing a program, the program controlling a computer to achieve:
a control function for performing a control of calculating position information of an object, on the basis of distances between a distance measurement sensor provided on a hinge-type door and the object, the distances being obtained by the distance measurement sensor at two or more positions in an opening/closing range of the door.
